(19) United States
(12) Patent Application Publication
(10) Pub. No.: US 2025/0365314 A1
(43) Pub. Date: Nov. 27, 2025

(54) CREATING COMPLEX HONEYNET ENVIRONMENTS WITH GENERATIVE ARTIFICIAL INTELLIGENCE

(71) Applicant: Crowdstrike, Inc., Sunnyvale, CA (US)

(72) Inventors: Michael Esfahani, San Jose, CA (US); Mikel Gastesi, Pamplona (ES); Alexander Hullmann, Overath (DE); Mikel Mugica, Bilbao (ES); Stefan Stein, Cologne (DE); Arnaud Wald, Grenoble (FR); Tanya Widen, Maikammer (DE)

(21) Appl. No.: 18/673,086

(22) Filed: May 23, 2024

(51) Int. Cl. H04L 9/40

(52) U.S. Cl. CPC H04L 63/1491

(57) ABSTRACT

Systems and methods for smart generation of content for a deceptive honeynet environment. The systems and methods generate a first prompt to an artificial intelligence (AI) model to generate a first output based on an initial input, receive the first output from the AI model, the first output comprising a first set of content, generate a second prompt to the AI model to generate a second output comprising a network configuration based on the first set of content and the initial input, receive the second output from the AI model, the second output comprising the network configuration, wherein the network configuration is consistent with the first set of content and the initial input, and store the first set of content and the network configuration.

### TECHNICAL FIELD

Aspects of the present disclosure relate to generating honeynet environments, and more particularly, to smart generation of honeynet environments using an artificial intelligence model.

### BACKGROUND

The use of honeypots or honeynets is a cybersecurity technique in which a potentially vulnerable service or system is created to capture and record exploitation attempts of the service or system. For example, a honeynet may include a whole company environment with workstations, servers, and network elements generated to deceive or lure a malicious actor to apply their TTPs (tactics, techniques, and procedures) and malware to the environment. The TTPs and malware may then be captured and analyzed for identification and future detection of the malicious actor by a cyber security platform.

Large language models are designed to understand and generate coherent and contextually relevant text. Large language models are typically built using deep learning techniques using a neural network architecture and are trained on substantial amounts of text data for learning to generate responses. The training process for large language models involves exposing the model to vast quantities of text from various sources, such as books, articles, websites, and other data.

Large language models use tokens as fundamental units into which text is divided for processing. Tokens are usually smaller units of text, such as individual characters, sub words (e.g., byte-pair encoding), or words. Large language models tokenize queries and general text documentation as part of its input processing, which enables large language models to manage large volumes of general text documentation efficiently. By breaking the text into tokens and representing text numerically, large language models can understand and generate responses based on the underlying patterns and relationships within the text.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram illustrating an example system architecture including a cybersecurity system with a honeynet system, in accordance with some embodiments of the present disclosure.

FIG. 2A is a block diagram that illustrates an example system for smart honeynet content generation using an artificial intelligence model, in accordance with some embodiments of the present disclosure.

FIG. 2B illustrates an example data flow 200B and dependencies for generating content in a honeynet environment using a generative artificial intelligence (AI) model, according to some embodiments.

FIG. 3 is a block diagram illustrating an example system for honeynet content generation using an artificial intelligence model, in accordance with embodiments of the present disclosure.

FIG. 4 is a flow diagram of an example method of generating content for a honeynet environment using a generative artificial intelligence model, in accordance with some embodiments of the present disclosure.

FIG. 5 is a flow diagram of another example method of generating honeynet content and configuration using a generative artificial intelligence model, in accordance with some embodiments of the present disclosure.

FIG. 6 is a block diagram of an example computing device that may perform one or more of the operations described herein, in accordance with some embodiments of the present disclosure.

### DETAILED DESCRIPTION

A honeypot is a cybersecurity technique used to gain insight into current cyber threats by simulating a potentially vulnerable service and recording exploitation attempts of that service. Conventional honeypots, however, do not provide authentic network level environments to capture more sophisticated cybersecurity threats and are thus limited to mostly capturing automated exploitation attempts. For a more complex environment including multiple honeypots, referred to herein as a honeynet, threat actors may manually assess the authenticity of the environment to determine whether it is an eligible target. As used herein, a honeypot is a single system or artifact for capturing cybersecurity threats and exploitation attempts while a honeynet is a network of multiple honeypots used in conjunction. Therefore, it is critical to the functionality of a honeynet environment to successfully deceive threat actors so that they proceed with their attacks. However, the generation of authentic honeynet environments may include the creation of an entire company network environment including workstations, servers, and network elements which may require a large amount of time to create. While tools may be available for building cloud infrastructure quickly and automatically, the workstations (e.g., virtual machines) need to be filled in with realistic content. For example, each workstation may include network related configuration, and information and files created by the user working on it. The manual generation of this content utilizes significant amounts of time and resources. Additionally, pulling such information from public resources on the internet results in an inconsistent impression and could easily be spotted by threat actors.

The present disclosure addresses the above-noted and other deficiencies by providing automated generation of consistent content for a honeynet environment using a generative AI model. In some embodiments, a user may provide a company profile with minimal descriptive information such as a simple company description, a size of the company, an industry vertical in which the company operates, or any other descriptive information about the company and a honeynet content generator may create a configuration of one or more networks (e.g., an overall network and subnetworks of the overall network) for the company as well as content to be incorporated throughout the one or more networks. In some embodiments, the honeynet content generator may query an AI model (e.g., a large language model (LLM)) to generate the configuration of the one or more networks and consistent content to be included in the one or more networks. In some embodiments, for each artifact to be included in the honeynet environment, a prompt to the AI model may be generated that not only generates content for the artifact, but also respects the content of any previously generated artifacts. For example, when generating email chains the prompt to the AI model may have the model utilize names of employees and their roles, that were previously generated artifacts, in the email chains. In some embodiments, the honeynet content generator may first create more fundamental artifacts such as an employee list, vendor list, and customer list, upon which other more complicated artifacts may depend, such as email conversations, payment data, etc.

As discussed herein, the present disclosure provides an approach that significantly reduces the time required to build honeynet environments. Additionally, embodiments further provide for consistent information across the honeynet environments. Thus, embodiments provide efficient generation of content that is consistent across the network configuration of a honeynet environment. As such, embodiments allow simulation of an authentic-appearing company network for collection of information about threat actors and current tools, tactics, and plans used by threat actors, in a cost-effective manner.

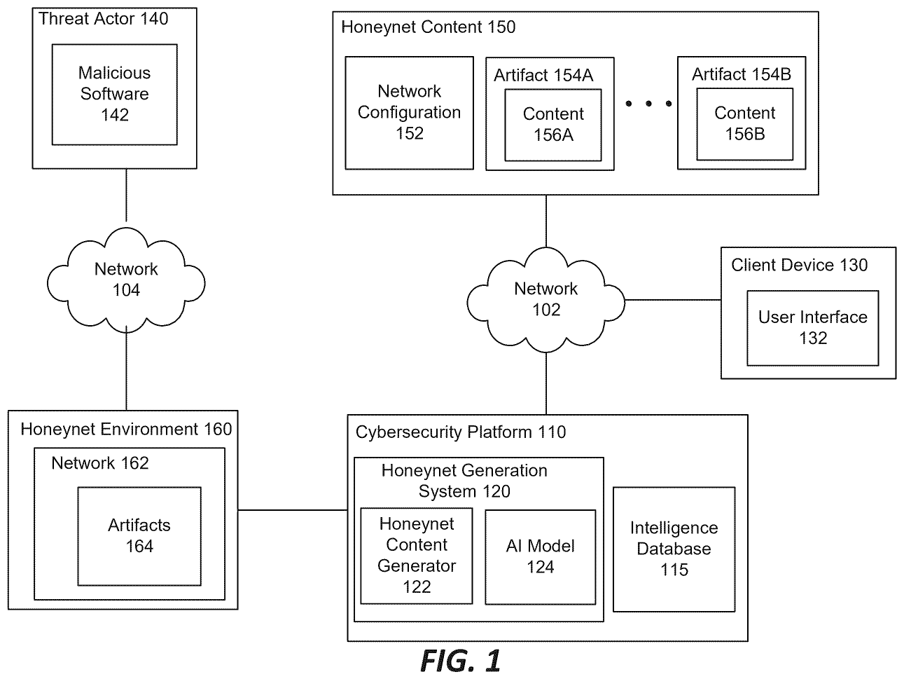

FIG. 1 is a block diagram illustrating a computing system architecture in which embodiments of the present invention may operate. Computing system architecture 100 may include a cybersecurity platform 110, a honeynet content platform 150, and a client device 130 coupled via a network 102. Network 102 may be any type of network such as a public network (e.g., the Internet), a private network (e.g., a local area network (LAN), Wi-Fi, or a wide area network (WAN)), or a combination thereof. Cybersecurity platform 110 may collect cybersecurity intelligence and monitor for cybersecurity threats. Cybersecurity platform 110 may be any data processing device or platform, such as a desktop computer, a laptop computer, a mainframe computer, a personal digital assistant, a rack-mount server, a hand-held device or any other device configured to process data. In some embodiments, the cybersecurity platform 110 may be deployed to a cloud computing infrastructure and operate in a cloud computing environment. In some embodiments, the cybersecurity platform 110 may include honeynet generation system 120 for generating and monitoring a honeynet environment (e.g., honeynet environment 160). The honeynet generation system 120 may include a honeynet content generator 122 and an AI model 124 which may operate in combination to generate honeynet content 150 for generating and deploying a honeynet environment 160. AI model 124 may be a generative AI model, such as a large language model (LLM). For example, the honeynet content generator 122 may include several modules for generating prompts for various content and artifact types based on an input received from a client device 130. In some embodiments, the honeynet generation system 120 may receive an input from the client device 130 (e.g., entered via user interface 132) including a company name and company description from which the honeynet content generator 122 may generate prompts for AI model 124 to generate various content that is consistent with the company name and description. Additionally, each prompt may include any previously generated content related to the current prompt so that the generated content is consistent with all previously generated content. Upon generating the honeynet content 150, the honeynet generation system 120 or other system may deploy a honeynet environment 160 based on the honeynet content 150. The honeynet environment 160 may then monitor whether any threat actors (e.g., threat actor 140) performs an attack on the honeynet environment 160. Threat actor 140 may access honeynet environment 160 via a network 104, such as the Internet. Network 104 may be any type of network such as a public network (e.g., the Internet), a private network (e.g., a local area network (LAN), Wi-Fi, or a wide area network (WAN)), or a combination thereof. The honeynet environment 160 may collect information associated with the threat actor 140 based on the attack such as any malicious software 142 used by the threat actor 140 as well as any other tools, tactics, and plans used by the threat actor 140. Such information can be collected by the honeynet environment 160 and stored in an intelligence database 115 of the cybersecurity platform 110 for detection and prevention of future attacks by the threat actor 140 or similar threat actors using the same TTPs or malware. Although AI model 124 is depicted as being incorporated within honeynet generation system 120 of cybersecurity platform 110 (e.g., hosted by a graphics processing unit (GPU) of the cloud environment in which the cybersecurity platform 110 is deployed), AI model 124 may be alternatively be hosted by a 3^{rd} party and may be invoked via an application programming interface (API) accessed by the honeynet generation system 120. For example, the honeynet generation system 120 may include the logic for generating prompts and calling the AI model 124 remotely (e.g., via the API).

In some embodiments, honeynet generation system 120 may initially generate an employee list for the provided profile. The company profile may include a company name and company description. The company description may include a size of the company (e.g., number of employees) and a vertical in which the company operates. The honeynet content generator 122 may generate the employee list based on the size of the company. Additionally, the honeynet content generator 122 may create one or more prompts to the AI model 124 to generate a network configuration to reflect such details of the company from the company profile, including the generated employee list. For example, a larger company with more employees would require a larger number of workstations corresponding to each employee in the employee list and would likely need several different networks within the overall company network. For example, the employee list may also include the departments for each employee and each department may have a separate network within the network configuration 152. The network configuration 152 may thus include the various networks within the company network, the workstations, network devices such as switches, routers, etc., servers, and so forth.

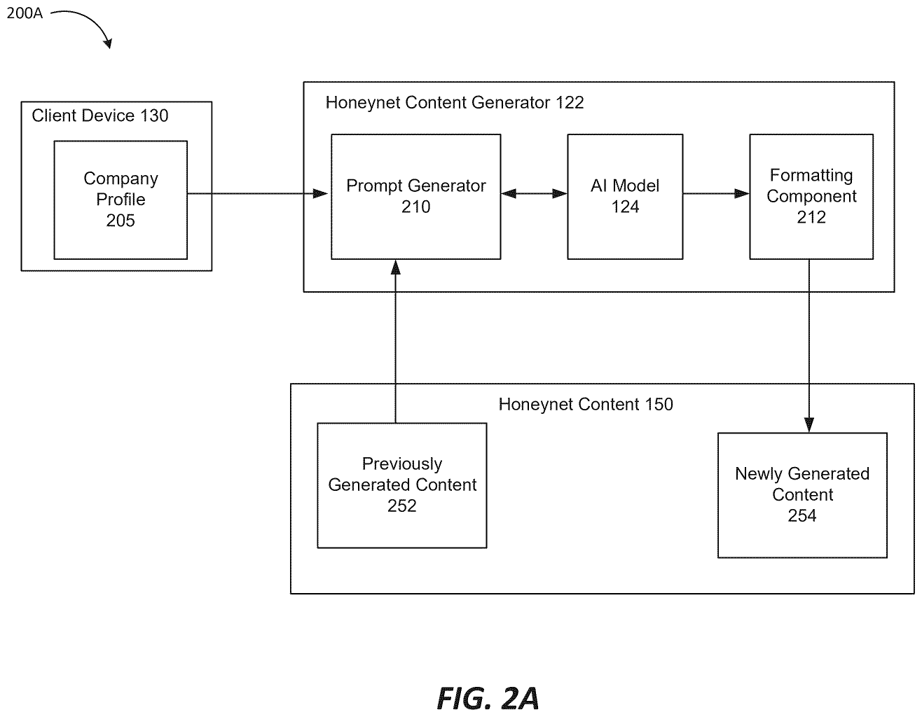

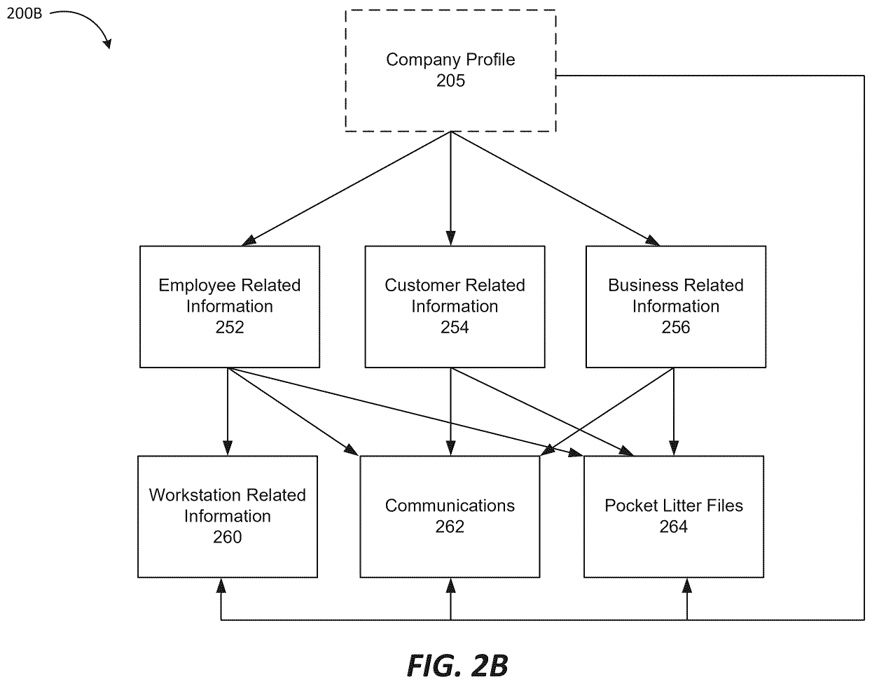

After creation of the employee list and the network configuration 152, the honeynet content generator 122 may include various modules to generate content for various corresponding artifact types. For example, the honeynet content generator 122 may include modules to generate, in addition to the employee list, a vendor list and a client list. Additionally, the honeynet content generator 122 may further include modules for generating realistic looking files and content to fill out the network. In some embodiments, the modules of the honeynet content generator 122 are configured to create one or more prompts including previously generated content. In some embodiments, the modules of the honeynet content generator 122 may include templates for generating prompts based on input received from a user (e.g., via client device 130). The honeynet content generator 122 may fill in the templates based on the received input. As described in more detail with respect to FIG. 2B, the modules may be arranged in a hierarchical manner such that more basic and fundamental information is generated first, such as the employee list, the client list, and the vendor list, after which the more complex content which relies on other previously generated content may be generated. For example, email conversations may be generated based on the employee list, client list, and the vendor list because the sender and receiver names will be included, and the details of the conversations may be determined from the context of the sender and receiver roles in the company or their relationship to the company.

The final output results from the AI model 124 for each module may be in a text format. The honeynet content generator 122 may then convert the output result into the corresponding format of the module and store it as an artifact (e.g., artifacts 154A-B) including the generated content (e.g., content 156A-B) at a data store (e.g., honeynet content 150). The honeynet generation system 120 may then generate the honeynet environment 160 based on the network configuration 152 and artifacts 154A-B. For example, the honeynet environment 160 may include one or more networks (e.g., network 162) which are configured based on the network configuration 152. Additionally, the honeynet generation system 120 may populate the networks 162 with artifacts 164 based on the network configuration 152 and the artifacts 154A-B. The honeynet environment 160 is thus a very detailed and authentic appearing deceptive environment to deceive a threat actor into initiating an attack on the honeynet environment 160. It should be noted that while only two artifacts are depicted in the honeynet content, any number of artifacts can be generated for the honeynet content.

FIG. 2A is a block diagram that illustrates an example system 200A for generating content for a honeynet environment, according to some embodiments. In some embodiments, system 200A includes a honeynet content generator 122 (e.g., of honeynet generation system 120 as described with respect to FIG. 1) for receiving a company profile 205 from a client device 130 and generating honeynet content 150. The honeynet content generator 122 may include a prompt generator 210, an AI model 124 and a formatting component 212. The prompt generator 210 may generate tailored prompts to the AI model 124 for creating various content to be included in artifacts of a honeynet environment. In some embodiments, the prompt generator 210 may initially generate a prompt for creating an employee list for the company based on the company profile 205. In some embodiments, the prompt generator 210 may then generate a network configuration for a honeynet environment based on the company profile 205 and the employee list. The company profile 205 may include a name of a company and a description of the company. For example, the company profile 205 may include a size of the company (e.g., number of employees), an industry vertical in which the company operates, a name of the company, and any other descriptive information that may be relevant for the particular honeynet environment being created.

In some embodiments, the prompt generator 210 may be part of a module for generating a particular type of content or artifact. Modules for different content types are described in further detail below with respect to FIG. 2B. In some embodiments, where generating content for fundamental artifacts that do not depend on other artifacts, the prompt generator 210 may generate a prompt to the AI model 124 to generate the content based on the company profile 205. For example, when generating an employee list the prompt generator 210 may generate a prompt that asks the AI model 124 to generate employee names and employee roles based on the size of the company and the vertical in which the company operates. In some embodiments, where generating more complex content that depends on other content, the prompt generator 210 may retrieve previously generated content 252 from the honeynet content 150 that is related to the content to be generated. For example, the prompt generator 210 may use the previously generated employee list to produce a prompt for generating a network configuration for the honeynet environment. Similarly, when generating content for user workstations, the prompt generator 210 may retrieve the employee list to generate consistent and relevant data for one or more of the employees in the employee list. As another example, to generate email chains the prompt generator 210 may retrieve or sample from previously generated employee list, customer list, or vendor list.

In some embodiments, to generate consistent outputs from the AI model 124, the prompt generator 210 may generate a series of prompts to frame or target the output content. For example, one or more prompts may request the AI model to create intermediate responses after which a final prompt may request the AI model 124 to generate a final output based on the intermediate responses. Thus, by providing the AI model 124 with a series of prompts to frame the output, the AI model 124 may generate responses in a consistent and predictable manner for content that can be incorporated into an artifact of the honeynet environment. After the AI model 124 has generated a final output of content for an artifact, the formatting component 212 may add the content to an artifact. For example, the formatting component 212 may convert the text output of the AI model 124 into the format corresponding to the artifact being generated. In some embodiments, the formatting component 212 may be specific to the module for which the artifact is being created. For example, the formatting component 212 may convert the text output of the AI model 124 into a portable document format (PDF) when the module is generating realistic looking pocket litter files. Similarly, if the module is generating email chains, the text output may be incorporated into an email format (e.g., sender, recipient, subject line, and body), such as the mbox format for collections of emails. Accordingly, the formatting component 212 may format the text into any corresponding format being generated by the honeynet content generator 122. In some embodiments, the final artifact output by the formatting component 212 may be stored as newly generated content 254 at the honeynet content 150 database or datastore. The newly generated content 254 will therefore be consistent and cohesive with the previously generated content 252.

FIG. 2B illustrates an example data flow 200B and dependencies for generating content in a honeynet environment using a generative AI model, according to some embodiments. As depicted, all content that is generated for a honeynet environment may depend on the company profile 205. In other words, every module of the honeynet content generator 122 may use the company profile 205 to prompt the AI model 124 to generate the content in conformity with the company profile 205. Additionally, one or more modules of the honeynet content generator 122 may first generate employee related information 252, customer related information 254, and business related information 256 based directly on the company profile 205. For example, a module to generate the employee related information 252 may prompt the AI model 124 to create, for example, a list of employees of the company based on a size of the company included in the company profile (e.g., create a list of employees including the number of employees indicated by the company profile 205) and based on the vertical of the company indicated by the company profile 205. For example, the positions or roles of the employees in the employee related information 252 may depend on the industry or vertical in which the company operates (e.g., a law firm may include different positions than a publicly traded company and a vehicle manufacturer may include different roles than a software development company). Similarly, the customer related information 254 may depend on the size of the company, the amount of business conducted by the company, and the vertical in which the company operates. In some embodiments, information may be pulled from publicly available sources to tailor content, such as the customer related information 254. Additionally, the business related information 256 may be generated similarly to the customer related information 254 based on the company profile 205 and publicly available information about vendors in the industry or vertical of the company and other various information regarding the business operations described in the company profile.

After generation of the more fundamental content such as employee related information 252, customer related information 254, and business related information 256, additional modules of the honeynet content generator 122 may generate more complex content and artifacts for the honeynet environment. For example, one or more modules may each generate workstation related information 260, communications 262, and pocket litter files 264. Each of these artifact types may depend on one or more of the employee related information 252, customer related information 254, and the business related information 256. Accordingly, the prompts to generate these artifacts may include such dependencies to maintain informational consistency across the artifacts. For example, workstation related information may depend on the employee related information 252 so the prompt generator 210 may include all or a portion of the employee related information 252, as well as the company profile 205, in the prompt to the AI model 124 to generate the content. Similarly, the prompt generator 210 may include all or part of the employee related information 252, the customer related information 254, and the business related information 256 in the prompt to generate communications 262. Furthermore, the prompt generator 210 may include all or part of the employee related information 252, the customer related information 254, and the business related information 256 in the prompt to generate the pocket litter files 264. Accordingly, the content may include consistent reference to the fundamental data provided in the initially generated data/lists. Additionally, in some embodiments, the context window of the output of the AI model may not allow all the content for a module to be generated by a single prompt or series of prompts. Therefore, the prompt generator 210 may also iteratively generate the content for a module by using previously generated content of the same type in the prompt to generate additional content of the same type with consistent information.

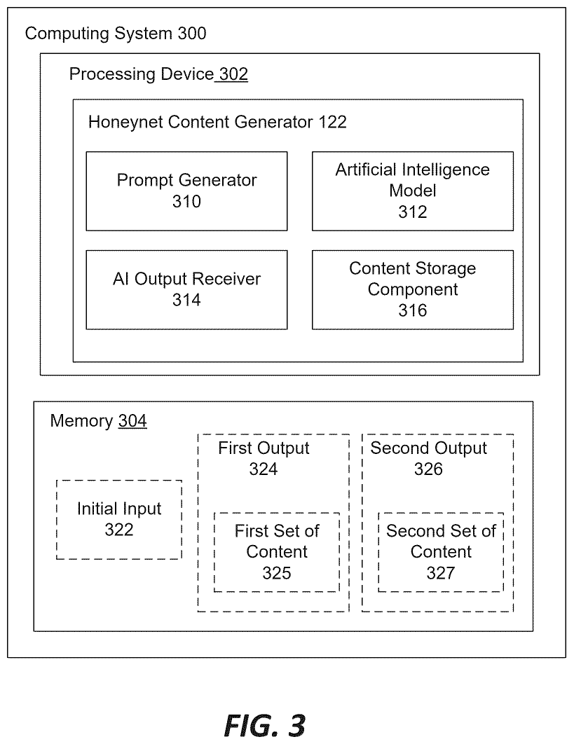

FIG. 3 is a block diagram depicting an example of a computing system 300 for generating content for a honeynet environment using an AI model, according to some embodiments. While various devices, interfaces, and logic with particular functionality are shown, it should be understood that computing system 300 includes any number of devices and/or components, interfaces, and logic for facilitating the functions described herein. For example, the activities of multiple devices may be combined as a single device and implemented on the same processing device (e.g., processing device 302), as additional devices and/or components with additional functionality are included.

The computing system 300 includes a processing device 302 (e.g., general purpose processor, a PLD, etc.), which may be composed of one or more processors, and a memory 304 (e.g., synchronous dynamic random-access memory (DRAM), read-only memory (ROM)), which may communicate with each other via a bus (not shown).

The processing device 302 may be provided by one or more general-purpose processing devices such as a microprocessor, central processing unit, or the like. In some embodiments, processing device 302 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 302 may include one or more special-purpose processing devices such as an application specific integrated circuit (ASIC), a field programmable gate array (FPGA), a digital signal processor (DSP), network processor, or the like. The processing device 302 may be configured to execute the operations described herein, in accordance with one or more aspects of the present disclosure, for performing the operations and steps discussed herein.

The memory 304 (e.g., Random Access Memory (RAM), Read-Only Memory (ROM), Non-volatile RAM (NVRAM), Flash Memory, hard disk storage, optical media, etc.) of processing device 302 stores data and/or computer instructions/code for facilitating at least some of the various processes described herein. The memory 304 includes tangible, non-transient volatile memory, or non-volatile memory. The memory 304 stores programming logic (e.g., instructions/code) that, when executed by the processing device 302, controls the operations of the computing system 300. In some embodiments, the processing device 302 and the memory 304 form various processing devices and/or circuits described with respect to computing system 300.

The processing device 302 executes a honeynet content generator 122 which may include a prompt generator 310, AI model 312, AI output receiver 314, and content storage component 316. In some embodiments, the AI model 312 may be deployed external to honeynet content generator 122 or on a separate computing system. For example, the honeynet content generator 122 may be accessible via a third-party API. Additionally, in some embodiments, the separate computing system executing the honeynet content generator 122 may include one or more graphics processing units (GPU), central processing units (CPU), or a combination thereof. In some embodiments, the prompt generator 310 may generate a first prompt to the AI model 312 to generate a first set of content for a honeynet environment. For example, the first prompt may include an initial input 322 received from a user. The initial input 322 may include a company profile (e.g., a description of a company) for generating a honeynet environment around the company profile. The AI model 312 may generate a first output 324 in response to the first prompt including a first set of content 325 and return the first output to an AI output receiver 314. In some embodiments, the AI output receiver may update a format of the first output 324 to a format corresponding to a first type of content. The formatted content may be referred to herein as an artifact, or content artifact, of the honeynet environment.

In some embodiments, the prompt generator 310 may additionally generate a second prompt to generate additional content that is consistent with the first set of content 325. For example, the second prompt may include the first set of content 325 or a subset of the first content with an indication for the AI model 312 to generate the second output 326 based on the first content. The AI model 312 may generate a second output 326 including the second set of content 327 that is consistent with the first set of content 325. The AI output receiver 314 may receive the second output 326 and format the second set of content 327 into a format corresponding to a second type of content. The content storage component 316 may store the first set of content and the second set of content to a data store (e.g., a cloud data store, a local data store, content database, or the like). In some embodiments, the prompt generator 310 may further generate a prompt to the AI model 312 to create a network configuration based on the initial input company profile. In some embodiments, the network configuration may be used to build a network environment for the company profile (e.g., a honeynet environment) and populate the network environment with at least the first set of content and the second set of content. It should be noted that although described as including a first and second prompt and corresponding output, embodiments may create any number of iterative, chained, or related prompts from various previously generated outputs to generate cohesive artifacts for a honeynet environment. For example, hundreds or thousands of prompts may be used, each dependent on one or more related or previous outputs of the AI model 312. In some embodiments, many prompts may be used to generate a single artifact of the honeynet environment.

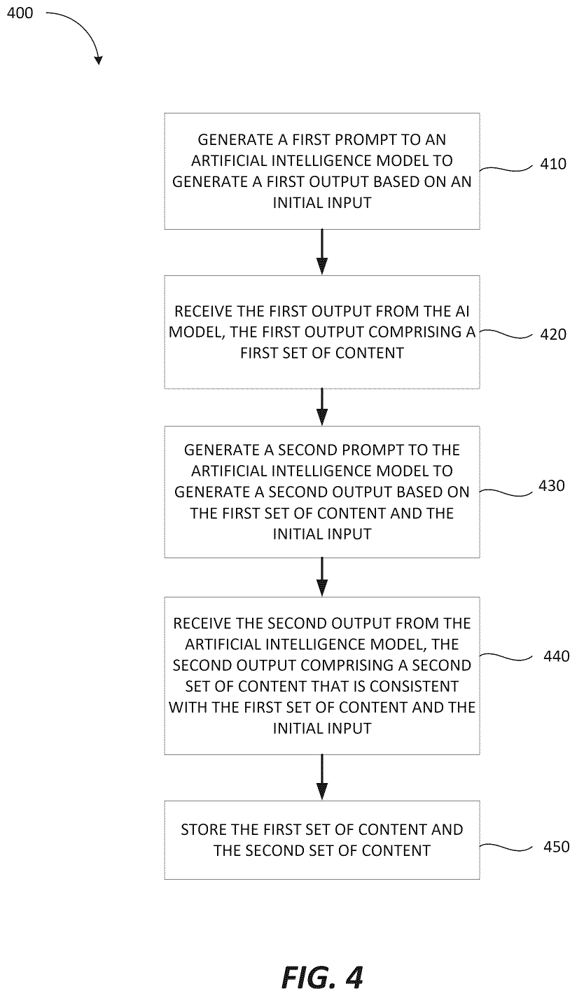

FIG. 4 is a flow diagram of a method 400 of generating content for a honeynet environment using an AI model, in accordance with some embodiments of the present disclosure. Method 400 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed by honeynet generation system 120 shown in FIG. 1 and/or honeynet content generator 122 shown in FIG. 2.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

With reference to FIG. 4, method 400 begins at block 410, where processing logic (e.g., honeynet content generator 122 of FIG. 1 and/or prompt generator 210 of FIG. 2) generates a first prompt to an artificial intelligence (AI) model to generate a first output based on an initial input. In some embodiments, the initial input includes a company profile including a description of the company. The company profile may include a name of the company, a size of the company, an industry in which the company operates, or any descriptive information.

At block 420, processing logic (e.g., honeynet content generator 122 and/or formatting component 212 of FIG. 2) receives the first output from the AI model, the first output comprising a first set of content. In some embodiments, the processing logic may convert the output of the AI model from a text format to a format corresponding to a first content type (e.g., the type of content requested by the prompt).

A block 430, processing logic (e.g., honeynet content generator 122 and/or prompt generator 210) generates a second prompt to the AI model to generate a second output based on the first set of content and the initial input. The second prompt may include the first set of content, or at least a portion of the first set of content, and the initial input. The second prompt may require the AI model to generate a second type of content with information that is consistent with the first set of content and the company profile. In some embodiments, the processing logic may iteratively perform such prompting for various types of content to fill out a honeynet environment.

At block 440, processing logic (e.g., honeynet content generator 122 and/or formatting component 212) receives the second output from the AI model, the second output comprising a second set of content that is consistent with the first set of content and the initial input. In some embodiments, the processing logic may convert the first output of the AI model to a first format corresponding to a first type of content and convert the second output of the AI model to a second format corresponding to a second type of content. In some embodiments, the second set of content comprises information that is dependent on the first set of content. In some embodiments, further prompts may be generated based on the first output and the second output of the AI model. It should be noted that any number of iterative and chained prompts may be created and provided to the AI model to produce sufficient content to fill out a honeynet environment in a cohesive and consistent manner.

At block 450, processing logic (e.g., honeynet content generator 122) stores the first set of content and the second set of content. In some embodiments, the processing logic also generates a third prompt to the AI model to generate a network configuration based on the initial input. In some embodiments, the processing logic may generate the third prompt prior to the first and second prompts. In some embodiments, the processing logic may build a network environment based on the network configuration and populate the network environment with the first set of content and the second set of content. In some embodiments, the processing logic may monitor the network environment for malicious activity and collect information associated with the malicious activity within the network environment.

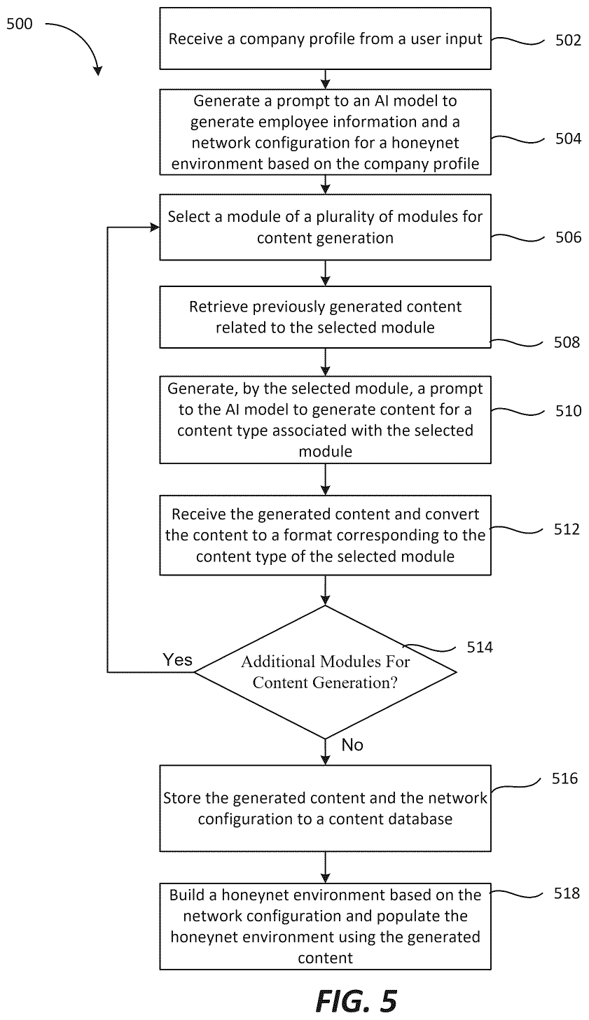

FIG. 5 is a flow diagram of a method 500 of generating content for a honeynet environment using an AI model, in accordance with some embodiments of the present disclosure. Method 500 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 500 may be performed by honeynet generation system 120 of FIG. 1 and/or honeynet content generator of FIGS. 1 and 2.

With reference to FIG. 5, method 500 begins at block 502, where processing logic receives a company profile from a user input. The company profile may include various details of the company including size, industry vertical, etc.

At block 504, processing logic generates a prompt to an AI model to generate employee information and a network configuration for a honeynet environment based on the company profile. For example, an initial prompt may request the AI model to create employee information. The same or an additional prompt may further request the AI model to create a network configuration based on the employee information and the company profile, including the size of the company and the industry vertical such that the number of workspaces and sub-networks reflect such a company.

At block 506, processing logic selects a module of a plurality of modules for content generation. Each module of the plurality of modules may include processing logic to generate one or more prompts to an AI model to generate a particular type of content for a honeynet environment. For example, the types of content of the honeynet environment may include fundamental information such as an employee information, customer information, and vendor information and more complex content generated based on the fundamental information.

At block 508, processing logic retrieves previously generated content related to the selected module. Previously generated content may be content generated by prior modules and may be different types of content or the same type of content. At block 510, processing logic generates, by the selected module, a prompt to the AI model to generate content for a content type associated with the selected module. At block 512, processing logic receives the generated content and converts the content to a format corresponding to the content type of the selected module.

At block 514, processing logic determines if any additional modules for content generation are available (e.g., have not yet been performed). If there are additional modules, the process returns to block 506 to repeat blocks 506-512 to generate additional content for the honeynet environment.

At block 516, processing logic stores the generated content and the network configuration to a content database. In some embodiments, the generated content is stored with a hash corresponding to each artifact. The hash may allow for future identification of the artifacts if they are found being distributed or shared in the wild or to identify the artifact as a honeynet artifact to other cybersecurity facets (e.g., to indicate that an actual breach has not occurred and rather that the artifact is from a deceptive honeynet environment). At block 518, processing logic builds a honeynet environment based on the network configuration and populates the honeynet environment using the generated content.

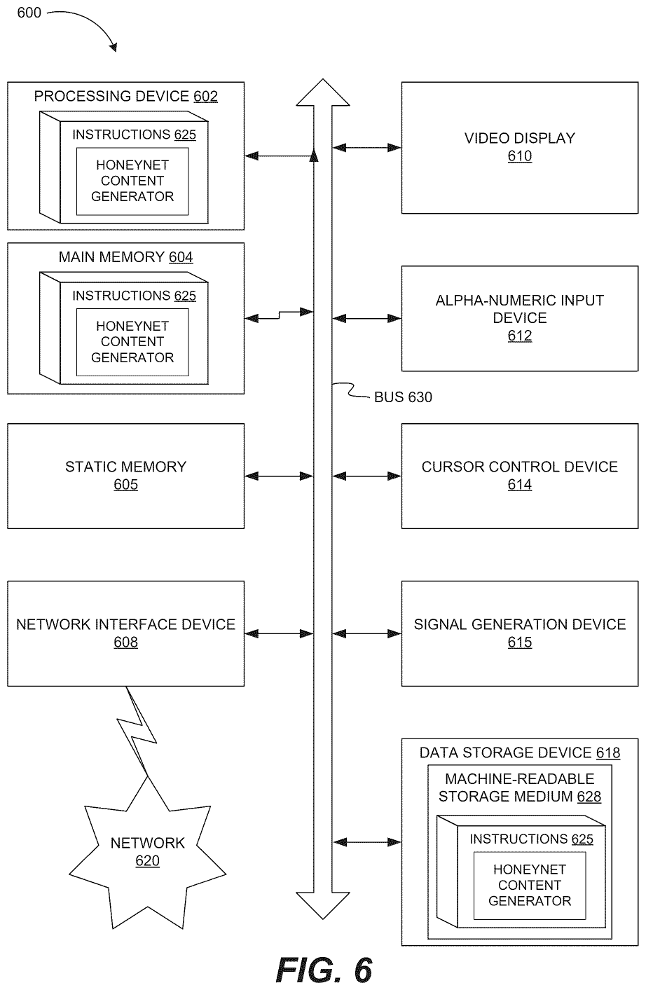

FIG. 6 illustrates a diagrammatic representation of a machine in the example form of a computer system 600 within which a set of instructions, for causing the machine to perform any one or more of the methodologies discussed herein.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, computer system 600 may be representative of a server.

The exemplary computer system 600 includes a processing device 602, a main memory 604 (e.g., read-only memory (ROM), flash memory, dynamic random access memory (DRAM), a static memory 606 (e.g., flash memory, static random access memory (SRAM), etc.), and a data storage device 618 which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computer system 600 may further include a network interface device 608 which may communicate with a network 620. Computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In some embodiments, video display unit 610, alphanumeric input device 612, and cursor control device 614 may be combined into a single component or device (e.g., an LCD touch screen).

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute honeynet content generator instructions 625, for performing the operations and steps discussed herein.

The data storage device 618 may include a machine-readable storage medium 628, on which is stored one or more sets of honeynet content generator instructions 625 (e.g., software) embodying any one or more of the methodologies of functions described herein. The honeynet content generator instructions 625 may also reside, completely or at least partially, within the main memory 604 or within the processing device 602 during execution thereof by the computer system 600; the main memory 604 and the processing device 602 also constituting machine-readable storage media. The honeynet content generator instructions 625 may further be transmitted or received over a network 620 via the network interface device 608.

The machine-readable storage medium 628 may also be used to store instructions to perform a method for intelligently scheduling containers, as described herein. While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “generating,” “storing,” “receiving,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
generating a first prompt to an artificial intelligence (AI) model to generate a first output based on an initial input;
receiving the first output from the AI model, the first output comprising a first set of content;
generating, by a processing device, a second prompt to the AI model to generate a second output comprising a network configuration based on the first set of content and the initial input;
receiving the second output from the AI model, the second output comprising the network configuration, wherein the network configuration is consistent with the first set of content and the initial input; and
storing the first set of content and the network configuration.

2. The method of claim 1, further comprising:
generating a third prompt to the AI model to generate a third output based on the first set of content, the network configuration, and the initial input; and
receiving the third output from the AI model, the third output comprising a second set of content that is consistent with the first set of content and the initial input.

3. The method of claim 2, further comprising:
building a network environment based on the network configuration; and
populating the network environment with the first set of content and the second set of content.

4. The method of claim 3, further comprising:
monitoring the network environment for malicious activity; and
collecting information associated with the malicious activity.

5. The method of claim 2, further comprising:
converting the first output of the AI model from a raw text format to a first file-type format corresponding to a first type of content, wherein the first file-type format comprises at least one of a portable document format (PDF), an mbox format, a slide deck format, or a text editor format; and
converting the second output of the AI model from a raw text format to a second file-type format corresponding to a second type of content, wherein the second file-type format comprises at least one of a portable document format (PDF), an mbox format, a slide deck format, or a text editor format.

6. The method of claim 2, wherein the second set of content comprises at least one of workstation related information, communications, or pocket litter files that are dependent on the first set of content, the first set of content comprising at least one of employee related information, business-related information, or customer-related information.

7. The method of claim 1, wherein the initial input comprises a company profile, the company profile comprising a description of the company.

8. A system comprising:
a processing device; and
a memory to store instructions that, when executed by the processing device cause the processing device to:
generate a first prompt to an artificial intelligence (AI) model to generate a first output based on an initial input;
receive the first output from the AI model, the first output comprising a first set of content;
generate a second prompt to the AI model to generate a second output comprising a network configuration based on the first set of content and the initial input;
receive the second output from the AI model, the second output comprising the network configuration, wherein the network configuration is consistent with the first set of content and the initial input; and
store the first set of content and the network configuration.

9. The system of claim 8, wherein the processing device is further to:
generate a third prompt to the AI model to generate a third output based on the first set of content, the network configuration, and the initial input; and
receive the third output from the AI model, the third output comprising a second set of content that is consistent with the first set of content and the initial input.

10. The system of claim 9, wherein the processing device is further to:
build a network environment based on the network configuration; and
populate the network environment with the first set of content and the second set of content.

11. The system of claim 10, wherein the processing device is further to:
monitor the network environment for malicious activity; and
collect information associated with the malicious activity.

12. The system of claim 9, wherein the processing device is further to:
convert the first output of the AI model from a raw text format to a first file-type format corresponding to a first type of content, wherein the first file-type format comprises at least one of a portable document format (PDF), an mbox format, a slide deck format, or a text editor format; and
convert the second output of the AI model from a raw text format to a second file-type format corresponding to a second type of content, wherein the second file-type format comprises at least one of a portable document format (PDF), an mbox format, a slide deck format, or a text editor format.

13. The system of claim 9, wherein the second set of content comprises at least one of workstation related information, communications, or pocket litter files that are dependent on the first set of content, the first set of content comprising at least one of employee related information, business-related information, or customer-related information.

14. The system of claim 8, wherein the initial input comprises a company profile, the company profile comprising a description of the company.

15. A non-transitory computer readable medium, having instructions stored thereon which, when executed by a processing device, cause the processing device to:
generate a first prompt to an artificial intelligence (AI) model to generate a first output based on an initial input;
receive the first output from the AI model, the first output comprising a first set of content;
generate, by the processing device, a second prompt to the AI model to generate a second output comprising a network configuration based on the first set of content and the initial input;
receive the second output from the AI model, the second output comprising the network configuration, wherein the network configuration is consistent with the first set of content and the initial input; and
store the first set of content and the network configuration.

16. The non-transitory computer readable medium of claim 15, wherein the processing device is further to:
generate a third prompt to the AI model to generate a third output based on the first set of content, the network configuration, and the initial input; and
receive the third output from the AI model, the third output comprising a second set of content that is consistent with the first set of content and the initial input.

17. The non-transitory computer readable medium of claim 16, wherein the processing device is further to:
build a network environment based on the network configuration; and
populate the network environment with the first set of content and the second set of content.

18. The non-transitory computer readable medium of claim 17, wherein the processing device is further to:
monitor the network environment for malicious activity; and
collect information associated with the malicious activity.

19. The non-transitory computer readable medium of claim 16, wherein the processing device is further to:
convert the first output of the AI model from a raw text format to a first file-type format corresponding to a first type of content, wherein the first file-type format comprises at least one of a portable document format (PDF), an mbox format, a slide deck format, or a text editor format; and
convert the second output of the AI model from a raw text format to a second file-type format corresponding to a second type of content, wherein the second file-type format comprises at least one of a portable document format (PDF), an mbox format, a slide deck format, or a text editor format.

20. The non-transitory computer readable medium of claim 16, wherein the second set of content comprises at least one of workstation related information, communications, or pocket litter files that are dependent on the first set of content, the first set of content comprising at least one of employee related information, business-related information, or customer-related information.
